(19) United States
(12) Patent Application Publication
(10) Pub. No.: US 2023/0315324 A1
(43) Pub. Date: Oct. 5, 2023

(54) METHOD FOR REDISTRIBUTING DATA WHEN A DISK ARRAY IS EXPANDED

(71) Applicant: OBSCHESTVO S OGRANICHENNOI OTVETSTVENNOSTJU "REYDIKS", Sankt-Peterburg (RU)

(72) Inventors: Aleksey Valerievich MAROV, Sankt-Peterburg (RU); Dmitry Segeevich SMIRNOV, Sankt-Peterburg (RU)

(73) Assignee: OBSCHESTVO S OGRANICHENNOI OTVETSTVENNOSTJU "REYDIKS", Sankt-Peterburg (RU)

(21) Appl. No.: 18/011,738

(22) PCT Filed: Jun. 14, 2021
(86) PCT No.: PCT/RU2021/050162

§ 371 Date: Dec. 20, 2022

(30) Foreign Application Priority Data
Jun. 24, 2020 (RU) 2020120913

(51) Int. Cl. G06F 3/06; G06F 11/14

(52) U.S. Cl. CPC G06F 3/0647; G06F 3/0607; G06F 3/0689; G06F 11/1415

(57) ABSTRACT

The invention relates to systems for storing data on disk drives and makes it possible to accelerate the redistribution of data. At least one physical disk drive is added to a disk array. The stripes of the data disk array are divided into groups, wherein the number of stripes from the original configuration of the array is selected such that, when data are migrated, they occupy an integer number of stripes. The data from each group of stripes are migrated successively to a pre-reserved data writing area, and then the data from this group of stripes is written to stripes of a new configuration of the disk array. When the size of a free area becomes greater than the size of a group of stripes for migration, the data from each group of stripes of the original disk array are migrated and written directly to the stripes of the new configuration.

### FIELD OF THE INVENTION

The present invention relates to a data storage system and methods for redistributing the data when a number of disks increase and RAID level change.

### BACKGROUND

A redistributing data process (restriping) is a process of moving a data from a disk array configuration in a data storage system with a checksum (RAID) to a different disk array configuration to increase the RAID physical space and thus a performance of the data storage system, and/or changing the RAID level to increase fault tolerance of the system.

A system and method for restriping data across a plurality of volumes based on the patent EP 1880324, publication 23 Jan. 2008, IPC G06F-003/06 is known. The method suggests distributing the data across volumes as stripes with identical numbers and redistributing the data when volumes are added. Redistribution of the data comprises determination whether the stripes are located on a correct amount of volumes and if not moving the stripes to the correct amount of volumes.

A patent CN 102880424, publication 28 Oct. 2015, IPC G06F-003/06 is known, where a system and method for redistributing data in a RAID system is disclosed. The method may be executed periodically, all time, after a change of a RAID-device, after a volume add and/or before the volume removal. The system includes a RAID subsystem and a volume dispatcher that is configured for automatic evaluation of each RAID-device.

The closest is a technical solution that is disclosed in the patent EP2021904, publication 2009 Feb. 11, IPC G06F-003/06. The solution relates to a system and method for redistribution a data in a RAID. The method provides transferring the data from an initial RAID device to an alternative RAID device and deletion of the initial RAID device.

At the same time a problem of increasing a performance of a redistribution data process during restriping remains relevant.

### SUMMARY OF THE INVENTION

The technical result of the present invention is to increase performance of a redistribution data process with an ability to initiate a user requests during the redistribution data process.

A method for redistributing data when a disk array is expanded during a computer system operation comprises the following steps:

Adding at least one physical disk to a disk array that comprises at least two disks with an initial data distribution across the disks in the disk array.

Splitting all stripes of an initial data disk array to groups that include K stripes, wherein the number of K stripes from an initial disk array configuration is chosen such that when transferring the data from the initial disk array configuration to a new disk array configuration, the transferred data, including calculated checksums for a new data array, takes integer number of M stripes.

After that sequentially transferring a data of each group of stripes of the initial disk array to a pre-reserved data recording area, and then storing the data of this group of stripes to a stripes of the new configuration disk array.

When a condition is met where a size of free volume between transferred and not transferred data of the new disk array configuration becomes larger than a size of a stripes that are transferred, the data of each group of stripes of the initial disk array are transferred and recorded directly to the stripes of the new data array configuration.

After transferring a last group of stripes of the initial disk array to the stripes of the new disk array configuration the redistribution of data is stopped. At the same time during the data transfer it is allowed to call a data array based on a user requests.

In one embodiment, when a condition is met where the size of free volume between transferred and not transferred data of the new disk array configuration becomes larger than a size of at least one transferred group of stripes, the data is transferred and recorded at least for two stripes of the group simultaneously.

In addition, when a condition is met where the size of free volume between transferred and not transferred data of the new disk array configuration becomes larger than a size of at least two transferred groups of stripes, the data is transferred and recorded for at least two groups of stripes.

At the same time a priority from 0 to 100 percent is set to a process of the data transfer that depends on calls based on a user requests. Priority adjustment is based on allocation a time period between transfer of one group of stripes and start time of transfer a following group of stripes.

In one embodiment, when the data is corrupted or lost during the redistribution process, the redistribution process is interrupted, the data is restored and after that continues transfer of a data of group of stripes.

In yet another embodiment, when the data is corrupted or lost during the redistribution process, the redistribution process should be completed and after that a data that was lost or corrupted should be restored.

In another embodiment, when the data is corrupted or lost during the redistribution process, the data recovery is performed simultaneously with the data transfer for those areas of the data array that do not fall into a current group of stripes to be transferred.

In this application the following terms are used:

Block—Disks in the RAID arrays are logically divided to a blocks of identical size.

Stripe—a sequence of the blocks with the same numbers located on different disks of the RAID array.

### FIGURES

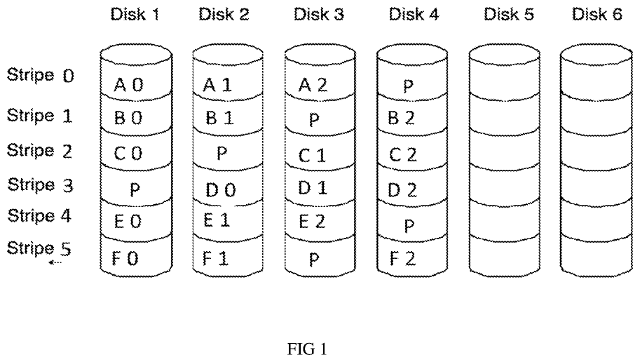

On a FIG. 1 is shown a state of a RAID array before start of a data transfer from an initial disk array configuration to a new disk array configuration.

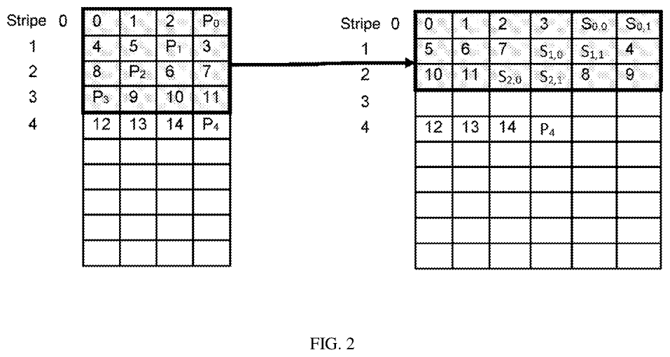

On a FIG. 2 is shown a scheme of a first iteration of a data transfer from an initial disk array configuration to a new disk array configuration.

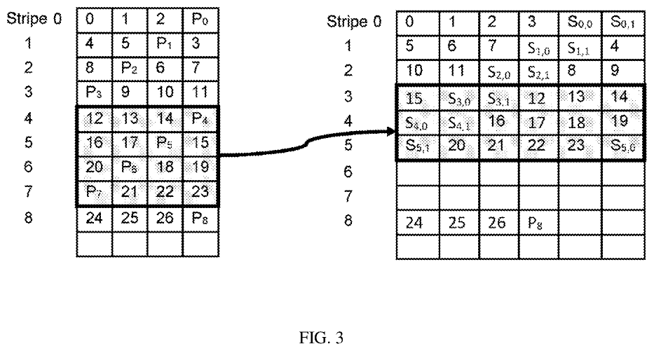

On a FIG. 3 is shown a scheme of a second iteration of a data transfer from an initial disk array configuration to a new disk array configuration.

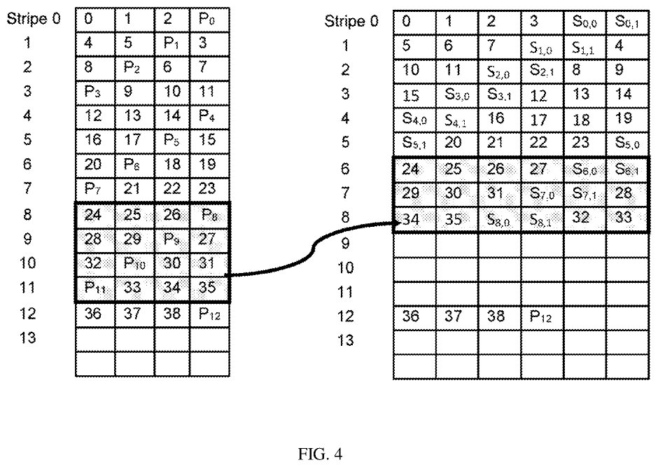

On a FIG. 4 is shown a scheme of a third iteration of a data transfer from an initial disk array configuration to a new disk array configuration.

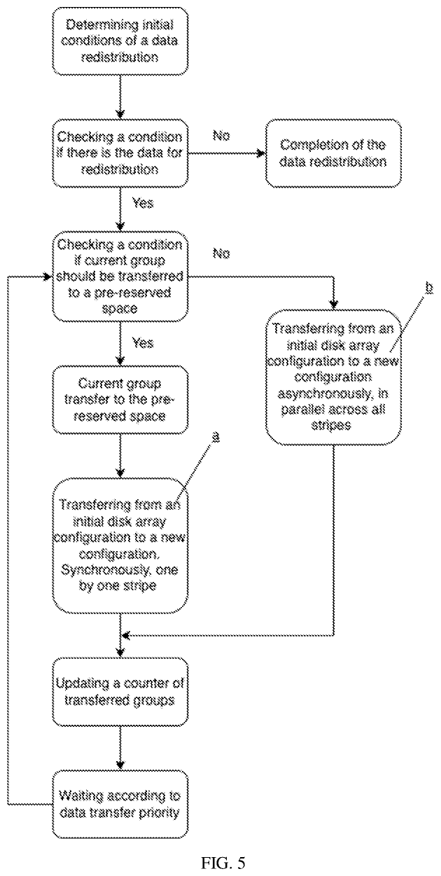

On a FIG. 5 is shown a block diagram of a process of a data redistribution.

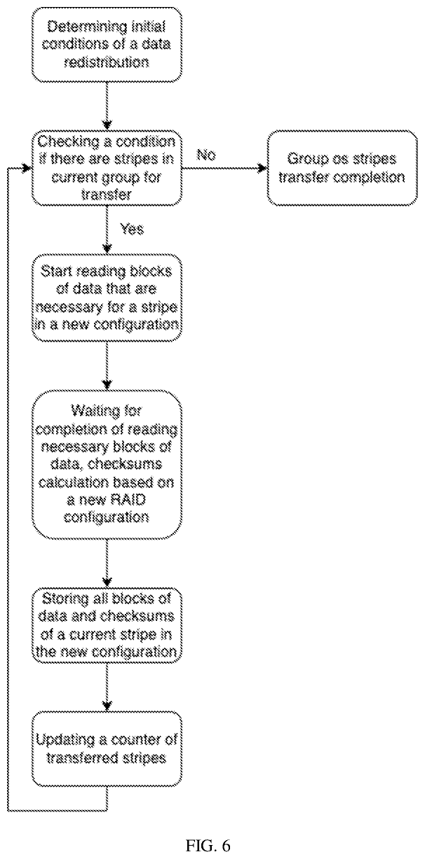

On a FIG. 6 is shown a block diagram of a process of sequential transfer of stripes of a single group.

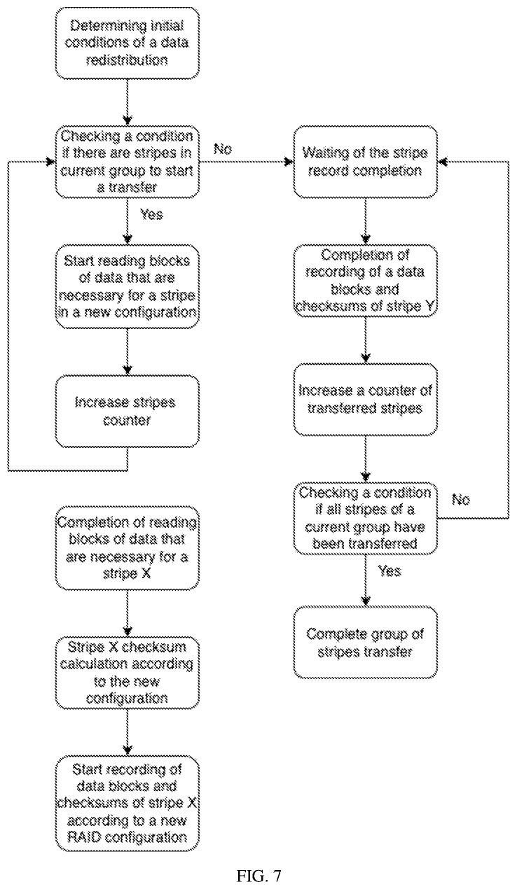

On a FIG. 7 is shown a block diagram of a process of parallel transfer of stripes of a single group.

On a FIG. 6 is shown a block diagram for adjusting speed of a data transfer based on different priority.

### DETAILED DESCRIPTION OF THE INVENTION

A method for redistributing data when a disk array is expanded during computer system operation relates to a data storage system when transferring from one disk array configuration to another after adding a disk to increase physical RAID space. It is also possible to change a RAID level to increase the system fault tolerance. An example of the disk array expansion is shown on FIG. 1. To four existing disks of an initial disk array configuration two disks are added and a new disk array configuration includes six disks.

Initially the disk array contains stripes A, B, C, D, E, F that each comprises blocks A1, A2, A3 with the data and checksums P of an initial RAID level in the stripe A and stripes A, B, C, D, E, F of the disks 1-4.

Expansion may be executed by adding new physical disks, or expanding of the disk array may be executed, for example, by adding another RAID array or a storage system as a RAID device.

All stripes A, B, C, D, E, F of the initial disk array are divided to groups that include K stripes. In the present method redistribution of the data occurs simultaneously for several stripes—group of stripes. This leads to acceleration of the data redistribution process because in the known methods the transfer is done for one stripe or for one block.

A number K of stripes in the group of stripes is chosen so that when transferring the data from the initial disk array configuration to the new disk array configuration the data that is transferred, including calculated checksums for the new disk array, takes integer M stripes.

After that the data of each group of stripes of the initial disk array is sequentially transferred to a pre-reserved free space for a data record (backup copy). A size of the pre-reserved free space for the data record is calculated to store maximum size of all data of the transferred group of stripes.

After that the data of these groups of stripes is recorded to the new disk array configuration.

A process for redistributing data, when the data of each group of stripes is firstly transferred to the pre-reserved space for the data record and after that to the stripes of the new disk array configuration is shown on FIG. 2-FIG. 4. Recording of the data to the pre-reserved free space during the data redistribution process is made to avoid the data corruption due to faults during the process. During the transfer new checksums for the data may be calculated to replace old Pi, where Pi stands for checksum for stripe “i” of an old RAID configuration. In this implementation example expansion of a RAID level is disclosed, which means new checksums Si,j should be calculated, where Si,j is the checksum number “j” in the stripe “i” of the new RAID configuration.

FIG. 2 shows a block diagram of a first iteration of the data transfer from the initial disk array configuration to the new disk array configuration. A step of recording the data to the pre-reserved free space is not shown in the figure. The first iteration comprises transferring the data of the first group of stripes from the old configuration to a new one. The data of the transferred group of stripes contains stripes 0-3 from the old configuration with the data stored in blocks 1-11 and checksums P₀-P₃. In the new disk array configuration the data and new checksums S_{0,0}-S_{2,0} and S_{0,i}-S_{2,i} should be stored in stripes 0-2. In one moment in time only one group of stripes should be transferred. Calls to the data in the stripes that are in transfer process based on a user requests are blocked till the end of the transfer of the group of stripes. Questions about priority of the data redistribution process or a process of user requests execution during the transfer are disclosed below.

After completion of the first iteration in the new disk array configuration between transferred data (stripes 0-2) and not transferred data (stripe 4 and following stripes) an empty, free of data stripe 3 is formed.

During a second iteration of the data transfer from the initial disk array configuration to the new disk array configuration (FIG. 3), a data of a group of stripes 4-7, blocks 12-23 and relevant checksums are transferred. They are stored in the new disk array configuration to stripes 3-5. New checksums are calculated. After completion of this iteration an empty area, free of data is formed from two stripes 6-7.

During a third iteration similar processes of transferring the data are executed, at first the data of a group of stripes is stored in free, pre-reserved free space and then transferred to stripes 6-8, blocks 24-35 and corresponding checksums of the new data array configuration. After completion of this iteration a free space is formed consisting of three stripes 9-11.

Thus, each iteration of the data transfer of the group of stripes to the new disk array configuration will expand free space between transferred and not transferred data. At some iteration, in the present example it is third iteration, a condition is met where the free space between transferred and not transferred data of the new disk array configuration becomes larger than a size of a group of stripes for the transfer.

After this condition is met, each group of stripes of the initial disk array configuration is directly transferred and stored to the new disk array configuration, bypassing the step of intermediate recording to pre-reserved space. Such transition in this method for redistributing data when a disk array is expanded during the computer system operation doesn't affect stored data and increases a performance of the data transfer.

Additionally, when the condition is met, transfer of stripes of a single group may be executed not sequentially stripe by stripe but in parallel for all stripes of the group. Thus, reading a data that is needed to calculate checksums based on the RAID level and an amount of disks in the new configuration, calculation of the checksums and storing the data is executed simultaneously for all stripes of the group. This method substantially increases performance of the data transfer.

Moreover, when the space between transferred and not transferred data of the new disk array configuration becomes larger than a size of several transferring groups of stripes, the data transfer may be executed in parallel not only for the single group of stripes but for several groups of stripes.

Thus, the data transfer to the free pre-reserved space should be done not always, but only at the beginning of the method for redistribution data when the disk array is expanded.

The method for redistributing data when the disk array is expanded is shown in the block diagram of FIG. 5. At the beginning an initial condition of redistributing the data are determined that comprise a number of a current group for transfer, a size of the group for transfer, a number of the groups in the RAID, a size of free space between transferred and not transferred data of the initial and the new disk array configuration, waiting time between transfer of the groups based on a priority. After checking whether a condition of redistributing the data has been completed, a check whether redistributing of the data using pre-reserved space should be executed or redistribution of the data can be executed directly from the data of each group of stripes of the initial disk array configuration to the stripes of the new disk array configuration. After completion of a next iteration of the data transfer, the transferred groups of stripes counter should be updated, and a cycle should be repeated.

It should be noted, that because of a counter of transferred groups and internal hash table, where during a restriping process for each group current number of user requests and request for the data transfer are stored, redistribution of the data may be executed without interruption of a user load on a main storage.

From the block diagram on FIG. 5, a transfer of a data of group of stripes may be executed synchronously, one by one stripe (block a) or asynchronously, in parallel across all stripes (block b). Thus, stripes in a group can be transferred one by one, e.g. sequentially (synchronously), or asynchronously, e.g. several stripes of the group at once.

FIG. 6 shows a block diagram of a synchronous, one by one stripe, sequential data redistribution. During a sequential transfer of stripes of a group for each stripe, in turn, a data that is necessary for checksum calculation according to the RAID level and amount of disk in the new configuration should be read. After that, read blocks and checksums are stored to a new location based on the new RAID configuration. Only after the stripe storing completion a next stripe can be processed.

FIG. 7 shows a block diagram of an asynchronous, parallel across all stripes, sequence of a data redistribution. During a parallel transfer of all stripes of a group, all blocks of a data of an old configuration that is needed for storing and a new configuration checksums calculation should be read. When all blocks of the data are read for a stripe X of the new configuration, the checksum based on a RAID level and amount of disks of the new configuration is calculated. This calculation can be performed simultaneously for several stripes. After checksum calculation for the stripe X its blocks and checksums based on the new configuration are recorded. Waiting for all stripes to be stored based on the new configuration. In case not all groups have been transferred there is a transitioning to a new group of stripes.

During a data transfer a disk from a RAID disk bucket may fail, the disk may be corrupted or another failure can happen in the data storage system, in this case corrupted data can be restored based on checksums stored in the RAID.

Three options are available for the data restoration during the redistribution.

In a first option when a data is lost or corrupted during a redistribution process, the redistribution process interrupts, the data is restored and the transfer of the data of groups of stripes continues.

In a second option when the data is lost or corrupted during the redistribution process, the redistribution process should be performed until completion and after that the data that has been lost or corrupted is restored.

In a third option when the data is lost or corrupted during the redistribution process, the data restoration is performed along with the redistribution process for those spaces of the disk array that are not in a current group of stripes for the transfer.

An important distinguishing feature of the method is an ability to manage a priority of the data redistribution or priority of user requests execution.

The priority is set by an administrator of the data storage system as a number from 0 to 100%. The priority controls a time, that the data redistribution process should wait between transferring of one group of restriping and start of transfer the following group of the data redistribution, for example, 5 milliseconds, thus reducing an impact on the user load.

In case the priority is set to 100% no delay happens between the transfer of one group and another group even if the user load exists, thus the data redistribution will execute with maximum performance.

In case the priority is set to 0% and the user load exists than the transfer will be postponed until the load terminates and then the data redistribution continues.

In case the priority is set between 0% and 100% then a postpone time is proportional to the priority. Thus the speed of the data redistribution can be controlled based on the priority and the user load.

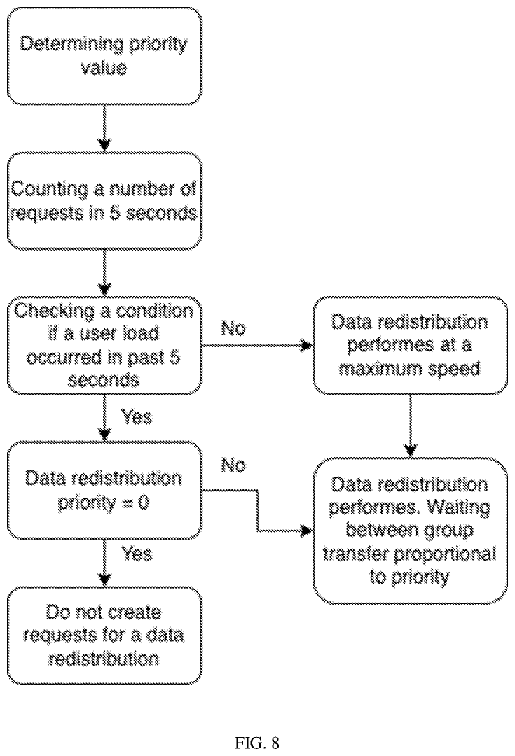

A method for the priority management is disclosed on a FIG. 8. The priority management is carried out based on counting number of requests during a predefined period of time and checking the user load on the data array during the predefined period of time.

### INDUSTRY APPLICABILITY

The method can be applied to increase performance of a RAID array and its size by expanding disk volume along with keeping the same level or increasing level of a data safety. During a redistribution of the data a RAID level can be changed. Additionally a user load on a system can be still in process and a priority between the redistribution of the data and the user load can be adjusted.

The method for redistributing the data—restriping goes more rapidly and is better oriented on a users requests of a data storing system, so the users requests may not be interrupted.

What is claimed is:

1. A method for redistributing a data when a disk array is expanded during a computer system performance characterized by,
a. Adding at least one physical disk to the disk array that comprises, at least, two disks with an initial data distribution across the disks in the disk array;
b. Splitting all stripes of an initial data disk array to groups that include K stripes, wherein the number of K stripes from an initial disk array configuration is chosen such that when transferring the data from the initial disk array configuration to a new disk array configuration, the transferred data, including calculated checksums for a new data array, took integer number of M stripes;
c. After that sequentially transferring a data of each group of stripes of the initial disk array to a pre-reserved data recording area, and then recording the data of this group of stripes to a stripes of the new configuration disk array;
d. When a condition is met where a size of free volume between transferred and not transferred data of the new disk array configuration becomes larger than a size of a stripes that are transferred, the data of each group of stripes of the initial disk array are transferred and recorded directly to the stripes of the new data array configuration;
e. After transferring a last group of stripes of the initial disk array to the stripes of the new disk array configuration the redistribution of data is stopped. At the same time during the data transfer it is allowed to call a data array based on a user requests.

2. The method of claim 1, characterized in that, when a condition is met where a size of free volume between transferred and not transferred data of the new disk array configuration becomes larger than a size of at least one transferred group of stripes, the data is transferred and recorded at least for two stripes of the group simultaneously.

3. The method of claim 1, characterized in that, when a condition is met where the size of free volume between transferred and not transferred data of the new disk array configuration becomes larger than a size of at least two transferred groups of stripes, the data is transferred and recorded for at least two groups of stripes.

4. The method of claim 1, characterized in that, a priority from 0 to 100 percent is set to a process of the data transfer that depends on calls based on a user requests.

5. The method of claim 4, characterized in that, the priority adjustment is based on allocation a time period between transfer of one group of stripes and start time of transfer a following group of stripes.

6. The method of claim 1, characterized in that, when the data is corrupted or lost during a redistribution process, the redistribution process is interrupted, the data is restored and after that continues transfer of a data of groups of stripes.

7. The method of claim 1, characterized in that, when the data is corrupted or lost during the redistribution process, the redistribution process should be completed and after that a data that was lost or corrupted should be restored.

8. The method of claim 1, characterized in that, when the data is corrupted or lost during the redistribution process, the data recovery is performed simultaneously with the data transfer for those areas of the data array that do not fall into a current group of the stripes to be transferred.
